(19) United States
(12) Patent Application Publication
(10) Pub. No.: US 2010/0140281 A1
(43) Pub. Date: Jun. 10, 2010

(54) Figure "8" pot & pan handle

(76) Inventor: Donald P. Meyers, Montrose, CO (US)

Correspondence Address: Donald P. Meyers, 61601 Tres Coyotes Trail, Montrose, CO, 81403, US

(21) Appl. No.: 12/592,978

(22) Filed: Dec. 7, 2009

Related U.S. Application Data
(60) Provisional application No. 61/201,403, filed on Dec. 10, 2008.

(51) Int. Cl. A47J 27/00

(52) U.S. Cl. 220/755

(57) ABSTRACT

The nature of the “figure “8” pot & pan handle is the unique design, with the Inner and outer loop. It is designed to be controlled with one hand and due to the Shorter length, be less of a safety issue while in use on a cooking surface. It should Provide a surer grip, in a couple of ways and hopefully a safer way to handle the job Of preparing meals.

### CROSS-REFERENCE TO RELATED APPLICATIONS

Figure “8” pot & pan handle Invention was originally filed in a provisional patent application No. 61/201,403 with a Filing date of Dec. 10, 2008.

### STATEMENT OF FEDERALLY SPONSORED R&D

“Not Applicable”

### REFERENCE TO SEQUENCE LISTING

“Not Applicable”

### BACKGROUND OF THE INVENTION

The only classification that seems to describe this invention, would be D 07 “Food Preparation Equipment”. Handling of food preparation vessels, in prior art, seems to Lack some considerations of safety in a couple of obvious ways; control of the vessel And area consumed by the size of the handles.

### BRIEF SUMMARY OF THE INVENTION

This new configuration for a cooking vessel handle is intended to improve the safe Usage of many types of pots & pans. Many pots & pans today are manufactured with Ever longer handles. They create situations, on a cooking surface, that can be unsafe. They offer the opportunity to be grasped with two hands, for lifting, but due to their Shape, leave them quite difficult to control with only one hand.

### BRIEF DESCRIPTION OF DRAWINGS

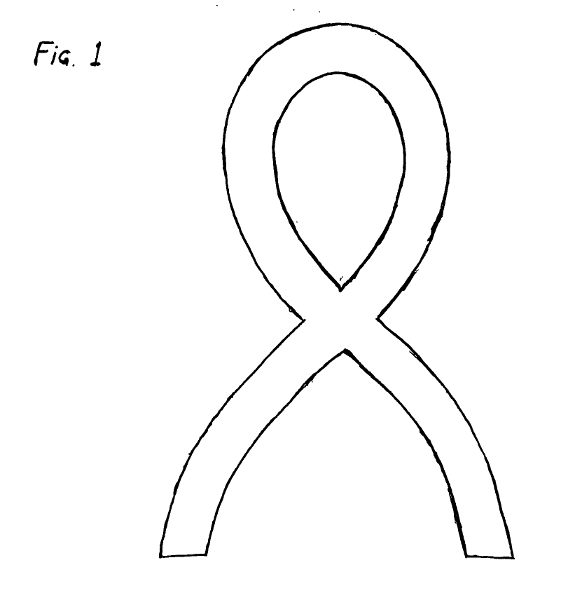

Drawing “FIG. 1” serves to give the shape of the invention, thus the title “figure “8”

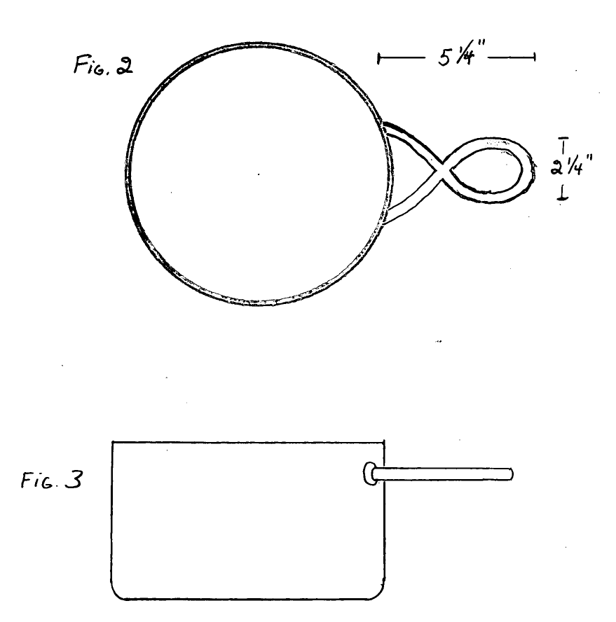

Drawings “FIG. 2” & “FIG. 3” serve to give the handle's relationship to an Approximately 3 Qt. saucepan and the size of the handle. Drawing “FIG. 3” serves To demonstrate the grip used to control the handle and vessel. The prototype handle Is constructed from ½″ square tubing, with a 1/16″ wall. The tubing is notched at the Point of intersection and bent into the desired shape “figure 8”. This could also be Accomplished by casting of metal into the configuration. The prototype's ends are Plugged and threaded to be attached to a vessel with a ¼″ oval head screw. Another Attachment could be to cast the handle with a plate, at the ends, that could be riveted To the vessel.

### DETAILED DESCRIPTION OF THE INVENTION

Cooking vessels that are manufactured and sold today, seem to have ever longer Handles. My assumption is that the manufacturers are trying to make them more Convenient to lift with two hands. This configuration, of the longer narrow handle, Creates two safety concerns. One being due to the narrowness of the handle, a person Attempting to pour out the contents of the vessel would have trouble controlling the angle Of the vessel using only one hand. The second safety concern is the length of the Handles. On a normal cooking surface the handles quite often interfere with each other Or overhang the edges of the cooking surface. Overhanging makes them more likely to Be inadvertently contacted by a person, resulting in an overturned vessel, creating an Unwanted clean-up chore or possible injury to the person.

This invention, the figure “8” pot & pan handle, would ameliorate both stated Problems. As shown in FIG. 2, the handle needs to extend only a little more than five Inches from the vessel body. This would obviously lessen the likely-hood of the handle Being accidentally contacted and the vessel upset. It would also cause there to be less Interference with the other vessels on the cooking surface.

Cooking something in a pot or pan eventually leads to the effort of removing The contents. Removal would normally be by the use of a spatula, to lift the items or A spoon or ladle to scoop out the contents. Quite often though, the contents would be Poured from the vessel.

Pouring out the contents of a cooking vessel is normally done while holding the Handle in one hand. Control of the angle of the vessel, while pouring with a normal Handle can be difficult, since the only governing factor would be the amount of Grasping pressure that can be applied to the narrow handle.

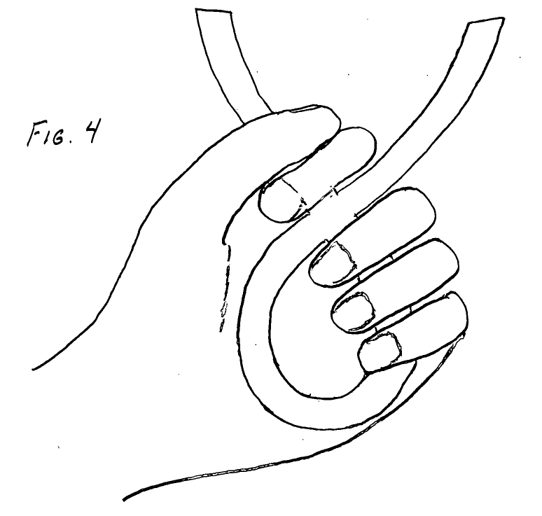

Demonstrated by the shape of the “figure “8” handle in FIG. 1, the location on The vessel as seen in FIG. 2 and FIG. 3 and the example, in FIG. 4, of the correct way to Grasp the handle, it is obviously easier to control while pouring.

Placing the index finger in the inner loop, of the “figure “8” handle, would Keep the handle from tending to slip out of the hand. The outer loop of the handle is Then grasped between remaining fingers and the palm of the hand. Due to the width Of the outer loop, two inches plus, the control of the vessel while pouring is enhanced.

The configuration of the figure “8” handle does allow it to be grasped and lifted Like a most other handles, but it can also be lifted by placing the index finger, or index And middle fingers into the inner loop, from above, and allowing the outer loop press Against the palm.

The construction of the figure “8” handle, in the prototype, is ½″ square steel Tubing. The tubing is bent, and notched at the crossing point and attached to the vessel By ¼″ machine screws. I believe, for mass production, it would be likely that the handle Would be cast in metal and quite likely have a non-slip coating applied.

1. The claim of the “figure “8” pot & pan handle” is the more ergonomic shape. It should provide a surer, safer way to control a cooking vessel, especially while Pouring out the contents, than the average handle in use today.
